(19) United States
(12) Patent Application Publication
(10) Pub. No.: US 2016/0240093 A1
(43) Pub. Date: Aug. 18, 2016

(54) Multimedia Presentation Device with Paper Pages and an Electronic Display

(71) Applicant: Disney Enterprises, Inc., Burbank, CA (US)

(72) Inventors: David Bossert, Stevenson Ranch, CA (US); Michael Fukumoto, Harbor City, CA (US); Quinn Smithwick, Pasadena, CA (US)

(73) Assignee: DISNEY ENTERPRISES, INC.

(21) Appl. No.: 14/620,887

(22) Filed: Feb. 12, 2015

(51) Int. Cl. G09B 5/06

(52) U.S. Cl. CPC G09B 5/062

(57) ABSTRACT

There is provided a multimedia book including a plurality of pages of print content, a cover covering the plurality of pages, a display covered by the cover, and an electronic module covered by the cover. The electronic module includes a memory having a media content stored therein, wherein each of a plurality of segments of the media content a corresponding page of the print content. The electronic module also includes a power source and a processor configured to detect a current page of the plurality of pages, wherein the current page is being viewed by the user, retrieve, from the memory, a first segment of a plurality of segments of the media content corresponding to the current page being viewed by the user, and playback, on the display, a first segment of a plurality of segments of the media content corresponding to the current page being viewed by the user.

### BACKGROUND

Print media is commonly presented on paper, including books and magazines. Paper books offer a unique reading experience, and many readers enjoy the tactile experience of paper books. The touch and feel of paper, combined with the way the light reflects off the page, makes reading a paper book a different experience from reading an electronic reader. Paper print is still a prolific and useful medium, and will continue to be found on coffee tables, waiting rooms, offices, schools, among other places, for years to come. However, paper print does have limitations. As an example, paper print lacks interactivity. Other limitations include the fact that paper print is not updateable and graphics in paper books are still.

### SUMMARY

There is provided a multimedia presentation device with paper pages and an electronic display, substantially as shown in and/or described in connection with at least one of the figures, and as set forth more completely in the claims.

### BRIEF DESCRIPTION OF THE DRAWINGS

FIG. 1 shows a diagram of an exemplary multimedia book, according to one implementation of the present disclosure;

FIG. 2 presents a multimedia book using conductive ink, according to one implementation of the present disclosure;

FIG. 3 presents a multimedia book with paper print pages connected to the processor by conductive traces, according to one implementation of the present disclosure; and

FIG. 4 shows a flowchart illustrating a method for presenting a multimedia content of a multimedia book, according to one implementation of the present disclosure.

### DETAILED DESCRIPTION

The following description contains specific information pertaining to implementations in the present disclosure. One skilled in the art will recognize that the present disclosure may be implemented in a manner different from that specifically discussed herein. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

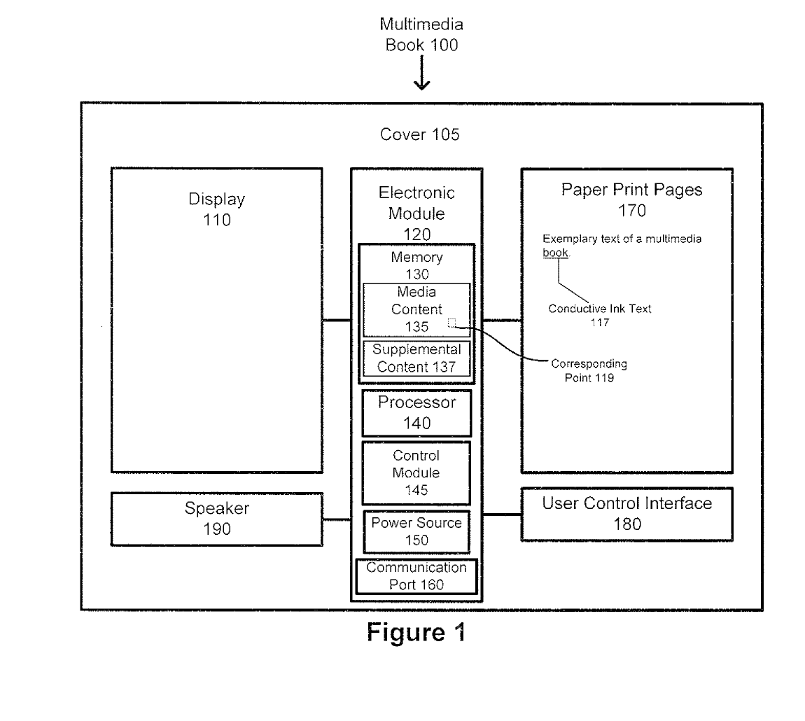

FIG. 1 shows a diagram of an exemplary multimedia book, according to one implementation of the present disclosure. As shown, multimedia book 100 includes cover 105, display 110, electronic module 120, paper print pages 170, user control interface 180, and audio output device 190. Electronic module 120 includes memory 130, processor 140, control module 145, power source 150, and may include communications port 160.

Cover 105 includes a front portion, a back portion, and a spine. Cover 105 can be a multi-fold cover, so that when the front portion is opened, there is an additional flap that can be opened further, positioning the additional flap such that pages of the book will not cover the additional flap while the book is being read. The multi-fold portion can also be an additional flap on the back portion of cover 105.

According to the implementation shown in FIG. 1, display 110 can be in the front portion of cover 105. In other implementations, display 110 can be in the back portion of cover 105. Display 110 can be configured to show video or photographic content of media content 135. In some implementations, the display may be a light emitting diode (LED) display, an organic LED (OLED) display, a liquid crystal display (LCD), a backlit LCD, a flexible OLED display, a flexible LED display, flexible LCD display, or other flexible display known in the art. To create a more interactive multimedia book, display 110 can be a touch-screen display. The display can be used to show media content related to the print content of the multimedia book. In some implementations, the display 110 can be placed at different locations in multimedia book 100. For example, display 110 can be included as an integrated part of cover 105, e.g., inside the front portion of cover 105 or inside the back portion of cover 105, where inside refers to the side of the portion of cover 105 facing the pages of the book. Display 110 can be placed on the outside of the front portion of cover 105 of multimedia book 100 or outside the hack portion of cover 105 of the multimedia book 100, where outside refers to the side of the cover that is visible when multimedia book 100 is closed.

In some implementations, multimedia book 100 can include a plurality of displays. An implementation may have a display inside the front portion of cover 105 and inside the back portion of cover 105, or on the outside of the front portion and inside the front portion of cover 105. However, placement of the display 110 is not limited to the portions of cover 105. In some implementations, display 110 or a plurality of displays can be interspersed with paper print pages 170 of multimedia book 100. Paper print pages 170 may contain a portion of a story, after which display 110 can be included as a following page to show a segment of media content 135. As such, a book having paper print pages 170 about a film can include segments of the film shown on display 110.

For example, multimedia book 100 may be a book about an animated film. Such a book may begin with a written section in paper print pages 170 that describe the animation process involved in making the film, and display 110 may playback a segment of media content 135 corresponding to the animation process. Next, multimedia book 100 may include another written section in paper print pages 170 about the voiceover process and voiceover actors involved in the making of the animated film, display 110 may playback another segment of media content 135 about the voiceover process and voiceover actors. While the instant example describes only two sections of written content and a display, multimedia book 100 may include any number of written sections and any number of display pages interspersed with paper print pages 170.

Yet, in some implementations, display 110 can be interspersed with paper print pages 170 by embedding display 110 into the page. Similar to including a display 110 as a full page, display 110 may be included in the page, like an illustration, a picture, or a graphic in multimedia book 100. In some implementations, display 110 can be embedded as a portion of a page, allowing media content 135, or segments thereof, to be displayed as the reader progresses through multimedia book 100. In some implementations, each display 110 of the plurality of displays can be configured to playback a corresponding segment of media content 135.

In order to playback media content 135, display 110 is electronically connected to electronic module 120. Electronic module 120 includes memory 130, hardware processor 140, and power source 150. Electronic module 120 may also include communication port 160.

Memory 130 is a non-transitory medium for storing data, and may be a non-volatile memory. Memory 130 includes media content 135, and may also include supplemental content 137. Media content 135 and supplemental content 137 can be audio content, visual content, audio and visual content, where visual content can include video, video clips, animation, photographs, or other graphics. In some implementations, media content 135 can be a movie or a short film. Supplemental content 137 can include advertisements, sponsorship messages, trailers for related movies, and other entertainment content, additional print content, complementary print content, or other audio/visual content to complement the paper print pages 170 of multimedia book 100. In some implementations, supplemental content 137 can include audio content, such as a sound track or additional commentary content. Other implementations include any combination of media content 135 and supplemental content 137 including any combination of audio and visual content. Media content 135 and supplemental content 137 can each be divided into a plurality of segments. Media content 135 and supplemental content 137 can be presented in whole, or according to the plurality of segments.

Presentation of media content 135 and supplemental content 137 occurs when processor 140 plays back a segment of content 135 and supplemental content 137 on display 110 and/or audio output device 190. In some implementations, a segment of media content 135 and supplemental content 137 can include only visual content, and accordingly playback will only use display 110. Similarly, a segment of playback on display 110 can include media content 135 and supplemental content 137 can include only audio content, and playback will only use audio output device 190. Also, playback may include playback of all of media content 135, all of supplemental content 137, or a segment that is less than all of media content 135 or supplemental content 137.

Electronic module 120 also includes processor 140, which may be electronically connected to display 110, memory 130, communication port 160, paper print pages 170, user control interface 180. Additionally, processor 140 can be configured to receive input from paper print pages 170, conductive ink text 117, or user control interface 180, and playback media content 135 and supplemental content 137 on display 110. Processor 140 can be configured to playback each segment media content 135 and supplemental content 137 on display 110. Control Module 145 is electronically connected to user control interface 180 and to media content 135. In some implementations, control module 145 receives input from conductive ink text 117 associated with a corresponding point 119 of media content 135 in memory 130. In some implementations, control module 145 receives input from page-turn controls associated with a corresponding point 119 of media content 135 in memory 130.

Multimedia book 100, using processor 140, begins playback of media content 135 and supplemental content 137 by detecting a corresponding point 119 to begin playback. Corresponding point 119 can be the beginning of media content 135 or supplemental content 137. In some implementations, corresponding point 119 can be at the beginning of a segment of media content 135 or supplemental content 137. Processor 140 can determine corresponding point 119 at which to begin playback by detecting the page currently being viewed, by conductive ink text 217 input, or by a default setting. A default setting can be a typical starting point where media content 135 or supplemental content 137 would begin playback, such as the beginning.

Power source 150 of electronic module 120 provides power to the multimedia book 100. In some implementations, power source 150 may be a battery. In some implementations, multimedia book 100 can have a display stand (not shown), where the display stand can be designed to recharge the battery using electronic pins or contacts when multimedia book 100 is placed on the display stand. Recharging of the battery of multimedia book 100 may be performed using a wire or wirelessly. For example, the battery of multimedia book 100 may be charged using conductive charging or inductive charging. In one implementation, the display stand for multimedia book 100 may be equipped with inductive charging, and the battery of multimedia book 100 may be charged while placed on the display stand providing an electromagnetic field to transfer wireless energy to the battery of multimedia hook 100.

Furthermore, electronic module 120 may include communication port 160. Communication port 160 can be used to communicate with other devices, for example, for updating media content 135 and supplemental content 137 in memory 130. Communication port 160 can be configured to connect electronic module 120 to a computer or computer network. In some implementations, communication port 160 can be configured to receive a communication cable such as a universal serial bus (USB) port, Firewire port, Ethernet cable port, telephone cable port, HDMI port. In some implementations, communications port 160 can be configured to receive a transferable memory device, such as an SD card, mini SD card, micro SD card, USB memory device (thumb drive), a memory stick, or other configurations of transferable memory known in the art. In some implementations, communication port 160 may communicate wirelessly, such that multimedia book 100 is wirelessly connectable to a computer or computer network using WiFi, cellular, Bluetooth, or other wireless technologies known in the art. Communications port 160 may also used to recharge the battery, e.g., using a USB cable.

In some implementations, a user can utilize the connectivity of the multimedia book to purchase additional media from the publisher of the book, from the studio that created the media content 135, or from third party media providers over the Internet. In some implementations, the user can load personal content, including photographs, images, video, or other personal content, onto multimedia book 100. As such, users are able to create personalized books, such as a scrapbook to commemorate life events like a family trip. Wireless connectivity can also allow updates for media content 135 and supplemental content 137 to be pushed to multimedia book 100 by the publisher of the book, the studio that created the movie or other media content, or third party media providers.

To create a multimedia experience that is functional and appealing, electronic module 120 can be integrated into multimedia book 100. In some implementations, electronic module 120 can be embedded in the spine of multimedia book 100. In some implementations, electronic module 120 can be partially in the spine, partially in cover 105 or completely in cover 105.

In order to playback media content 135 on display 110, processor 140 can be configured to receive input from user control interface 180. User control interface 180 can include traditional media playback controls such as play, pause, stop, forward, reverse, scene skip, and menu. User control interface 180 can be a traditional interface having buttons. Buttons on user control interface 180 can be physical buttons, capacitive buttons, resistive buttons, or other buttons known in the art. In some implementations, user control interface 180 can be integrated into display 110, e.g. using a touch-screen user control interface 180. In some implementations, user control interface 180 can include controls other than buttons, such as conductive ink and page-turn controls.

In some implementations, the current page can be detected by an electronic signal being sent from paper print pages 170 to processor 140 by, for example, an electronic contact. In such an implementation, each page of paper print pages 170 can send a signal to processor 140 corresponding to the page that is currently being viewed. In some implementations, this could be a physical connection, e.g., an electronic contact to indicate multimedia hook 100 is open to the corresponding page. In some implementations, a proximity detector, indicating that multimedia book 100 is open to the corresponding page, may send the signal. In some implementations, multimedia book 300 can be written with the content of paper print pages 170 divided into sections, and each section can correspond to a segment of media content 135. Multimedia book 100 can be configured such that each segment of media content 135 corresponds to a page of paper print pages 170. In some implementations, multimedia book 100 can detect the currently viewed page, can have conductive ink text 117, or both page detection and conductive ink text. Page detection and conductive ink text 117 are discussed in detail below. Although the present disclosure refers to paper print pages 170, it should be noted that pages of print content can be of different materials, e.g. plastic or any material on which ink can be printed.

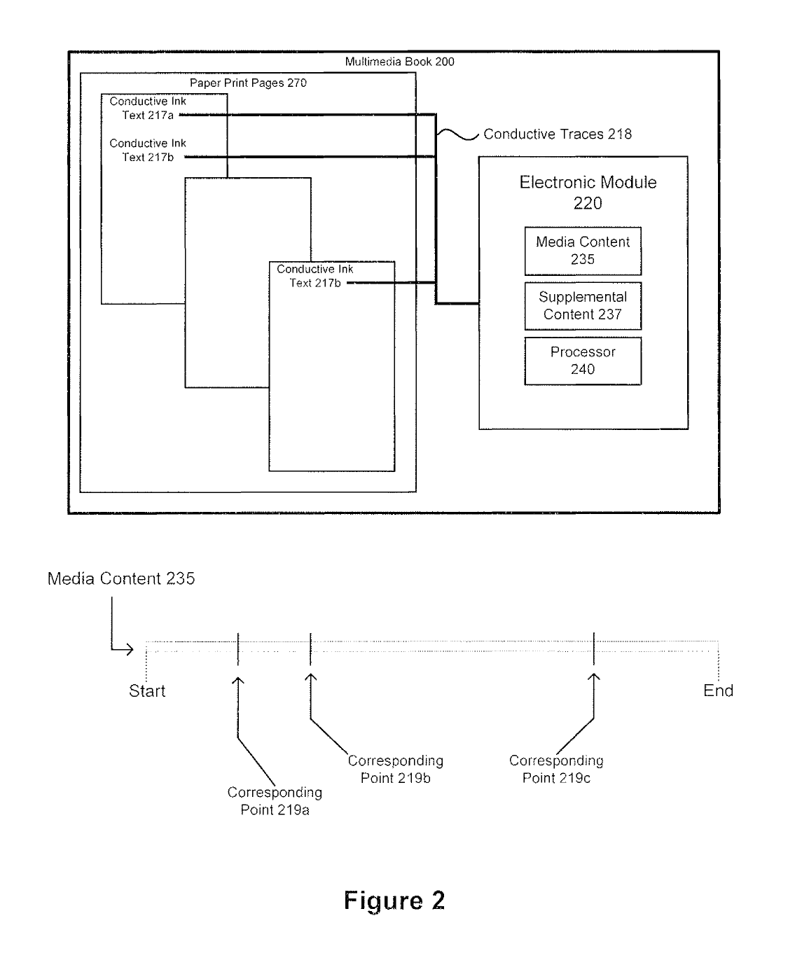

Conductive ink is ink that can be used in printed text or graphics that, when touched, acts like a button. Referring to FIG. 2, paper print pages 270 can include text printed in conductive ink, such as conductive ink text 217. Conductive ink text 217a-care connected to electronic module 220 using conductive traces 218. Conductive text 217a corresponds to corresponding point 219a, conductive text 217b corresponds to corresponding point 219b, conductive text 217c corresponds to corresponding point 219c. Corresponding point 219 can be a point in media content 235 or in supplemental content 237. In some implementations, each page of paper print pages 270 contains conductive text. In other implementations, some pages of paper print pages 270 contain conductive ink text 217 and other pages do not, as shown in FIG. 2. The conductive ink may appear in a different color for ease of user perception. In FIG. 2, each corresponding point 219a-c corresponds the beginning of a segment of media content 235, and media content 235 is depicted as a timeline to demonstrate how conductive ink text 217 corresponds to corresponding point 219 media content 235. When a user touches conductive ink 217, playback of media content 235 or supplemental content 237 begins at corresponding point 219. Conductive ink text 217 can be electronically connected to electronic module 220 by conductive traces 218. In some implementations, a page can have one instance of conductive ink text 217, more than one instance of conductive ink text 217, or no instances of conductive ink text 217.

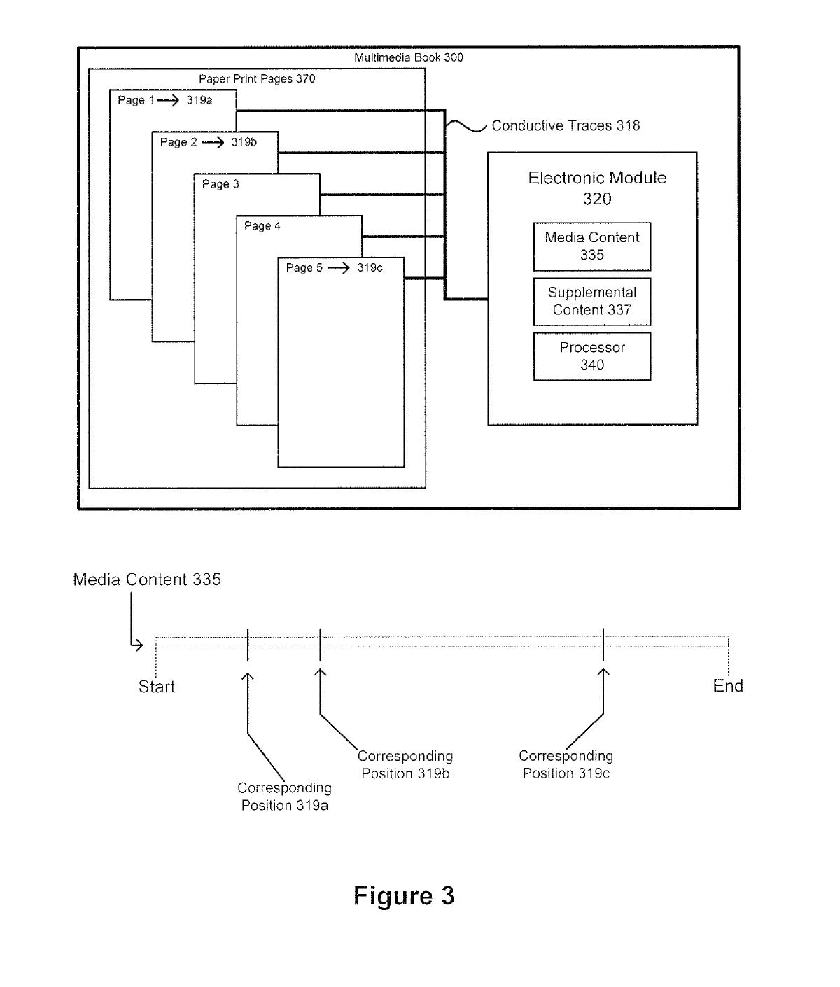

FIG. 3 shows paper print page 370 that is associated with corresponding point 319. To associate paper print pages 370 with corresponding point 319, paper print pages 370 can be electronically connected to electronic module 320 by conductive traces 318. As shown in FIG. 3, Page 1 is associated with corresponding point 319a, Page 2 is associated with corresponding point 319b, and Page 5 is associated with corresponding point 319c. Thus, when a reader is viewing Page 1, control module 337, through processor 340, cues the playback of media content 335 to corresponding point 319a. At this point, if the reader initiates playback of media content 335, processor 340 retrieves the corresponding segment of media content 335 from the plurality of segments stored in memory 330, and the playback begins at corresponding point 319a. If the reader is viewing Page 2 and initiates playback, playback of media content 335 begins at corresponding point 319b. In some implementations, each page can be associated with a corresponding point 319 in media content 335, with each successive page advancing through media content 335. In some implementations, as shown in FIG. 3, some pages are associated with a corresponding point, while others are not. In some implementations, even pages that are not associated with a corresponding point are still connected to processor 340. Multimedia book 300 can be configured to playback the entirety of media content 335 at once, or it can be configured to playback media content 335 in a plurality of segments that make up media content 335.

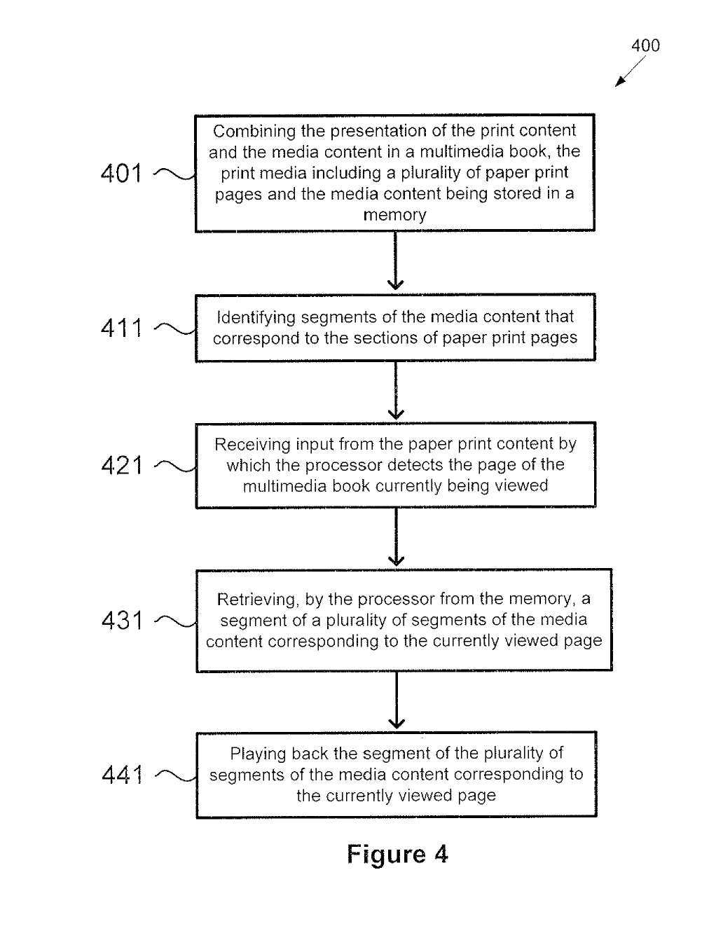

FIG. 4 shows flowchart 400 illustrating a method for presenting a multimedia content of a multimedia book, according to one implementation of the present disclosure. Flowchart 400 begins at 401 with combining paper print pages 170 and media content 135 in multimedia book 100, where media content 135 is stored in memory 130 and multimedia book 100 includes display 110. Print media of paper print pages 170 is divided into a plurality of sections and media content 135 is divided into a plurality of segments. At 411, processor 140 identifies segments of media content 135 that correspond to sections of print media in paper print pages 170.

As a reader of multimedia book 100 progresses through paper print pages 170, at 421, processor 140 receives input from paper print pages 170. Input from paper print pages 170 may come from conductive ink text 117, or by a signal indicative of a page currently being viewed by the reader. Input form paper print pages 170 may be communicated to processor 140 using conductive traces 218. Based on the input received from paper print pages 170, at 431, processor 140 retrieves, from the plurality of media segments stored in memory 130, the segment of media content 135 corresponding to the currently viewed page or the selected conductive ink text 117. At 441, processor 140 plays back on display 110, the corresponding segment of media content 135 retrieved from memory 130, based on the input received from paper print pages 170, where the playback of the corresponding segment beings at corresponding point 119.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described herein, but many rearrangements, modifications, and substitutions are possible without departing from the scope of the present disclosure.

What is claimed is:

1. A multimedia hook comprising:
a plurality of pages of print content;
a cover covering the plurality of pages;
a display covered by the cover; and
an electronic module covered by the cover, the electronic module including:
a memory having a media content stored therein, wherein each of a plurality of segments of the media content a corresponding page of the print content;
a power source;
a processor configured to:
detect a current page of the plurality of pages, wherein the current page is being viewed by the user;
retrieve, from the memory, a first segment of a plurality of segments of the media content corresponding to the current page being viewed by the user; and
playback, on the display, the first segment of the plurality of segments of the media content corresponding to the current page being viewed by the user.

2. The multimedia book of claim 1, wherein the cover includes a spine, and wherein the spine includes at least a portion of the electronic module.

3. The multimedia book of claim 1, wherein the plurality of pages of print content further comprise conductive ink, wherein the conductive ink is coupled to the processor using a conductive trace for corresponding to a segment of the media content by the processor.

4. The multimedia book of claim 1 further comprising a plurality of displays including the display.

5. The multimedia book of claim 4, wherein at least one of the plurality of displays is interspersed with the plurality of pages of print content.

6. The multimedia book of claim 1, wherein the display is one of an OLED, LED, and LCD panel.

7. The multimedia book of claim 1, wherein the display is a touch-screen display.

8. The multimedia book of claim 1, wherein the memory further comprises a supplemental content stored therein.

9. The multimedia book of claim 1, wherein the memory is updateable.

10. The multimedia book of claim 1, wherein the multimedia book is connectable to a computer network.

11. A method of presenting multimedia content in a multimedia book comprising a cover including a spine, a display, a plurality of pages of print content, a processor, and a memory having a media content stored therein, the method comprising:
detecting, by the processor, a current page of the plurality of pages of print content, wherein the current page is being viewed by the user;
retrieving, by the processor from the memory, a first segment of a plurality of segments of the media content corresponding to the current page being viewed by the user; and
playing back, on the display, the first segment of the plurality of segments of the media content corresponding to the current page being viewed by the user.

12. The method of claim 11, wherein the spine includes at least a portion of the electronic module.

13. The method of claim 11, wherein the plurality of pages of print content further comprise conductive ink, wherein the conductive ink is coupled to the processor using a conductive trace for corresponding to a segment of the media content.

14. The method of claim 11, wherein the multimedia book comprises a plurality of displays including the display.

15. The method of claim 14, wherein at least one of the plurality of displays is interspersed with the plurality of pages of print content.

16. The method of claim 11, wherein the integrated display is one of an OLED, LED, and LCD panel.

17. The method of claim 11, wherein the display is a touch-screen display.

18. The method of claim 11, wherein the memory further comprises a supplemental content stored therein.

19. The method of claim 11, wherein the memory is updateable.

20. The method of claim 11, wherein the multimedia book is connectable to a computer network.
